(19) United States
(12) Patent Application Publication
(10) Pub. No.: US 2014/0064918 A1
(43) Pub. Date: Mar. 6, 2014

(54) DEVICE AND SYSTEM FOR HARVESTING THE ENERGY OF A FLUID STREAM

(71) Applicants: Allan Hurup, Nibe (DK); Claus Burchardt, Gistrup (DK)

(72) Inventors: Allan Hurup, Nibe (DK); Claus Burchardt, Gistrup (DK)

(73) Assignee: COMPOENERGY APS, Gistrup (DK)

(21) Appl. No.: 14/110,972

(22) PCT Filed: Apr. 10, 2012
(86) PCT No.: PCT/DK2012/050113

§ 371 Date: Nov. 21, 2013

(30) Foreign Application Priority Data
Apr. 12, 2011 (DK) PA 2011 70173

(51) Int. Cl. F03D 3/04; F01D 17/16

(52) U.S. Cl. CPC F03D 3/04; F01D 17/167
USPC 415/4.1; 415/166

(57) ABSTRACT

Device for harvesting the energy of a fluid stream comprising a turbine with a rotation axis at right-angle to the fluid stream, the turbine comprising a plurality of blades that during its rotation sweeps an annular area around the rotation axis which has an inner and outer perimeter with a first and second radial distance to the rotation axis, and first and second fluid guide located opposite each other, with the plurality of blades arranged for rotation there between and arranged for guiding the fluid stream towards the at least one blade, wherein the first and second fluid guide are formed each with a guide foil section having a suction side, a pressure side and a guide foil incidence angle, wherein each fluid guide is arranged such that the suction sides of the guide foil sections are facing each other, wherein an open central area around the rotation axis is provided.

### FIELD OF THE INVENTION

The present invention relates to a device and a system for harvesting the energy of a fluid stream.

### BACKGROUND OF THE INVENTION

Since ancient times man have developed devices for harvesting the energy of fluid streams and converting the energy in order to power other devices such as water pumps, grain mills, cranes and in recent times; electrical generators.

Water wheels or tide mills are an example of such devices for harvesting the energy of a fluid stream, where the fluid stream is water, for example a river or tides.

Windmills are another example of such devices for harvesting the energy of a fluid stream, where the fluid stream is air, for example the wind.

Due to the finite availability of fossil fuels for producing energy combined with the oil crises of the nineteen seventies, there has been an increasing focus since then to decrease the reliance on fossil fuel and increase the amount of energy produced using renewable energy sources.

For this purpose various types of modern wind generators have been developed since the nineteen seventies, for example horizontal axis wind turbines having their rotation axis substantially in the wind direction and vertical axis wind turbines having their rotation axis substantially at right angle to the wind direction.

Horizontal axis wind generators are provided with a rotor at the end of a rotor shaft that is substantially horizontal, such that the rotor faces the wind. The rotor comprises a number of blades. As the wind is blowing onto the blades the rotor starts to turn. The rotor typically drives an electrical generator. The power generated by the horizontal axis wind turbine at a given wind speed is mainly a function of the rotor diameter and the aerodynamics of the blades. A horizontal axis wind turbine requires a yaw arrangement to point the rotor into the wind to be effective. Vertical axis wind generators are also provided with a rotor comprising blades and a rotor shaft.

The rotor shaft is substantially vertical and the blades extend along the rotor shaft. There are different types of vertical axis turbines. In one type known as a Darrieus turbine described in U.S. Pat. No. 1,835,018 the blades are curved and attached to the rotor shaft at either end or straight and suspended at a distance from the shaft and extending in parallel to the shaft. The wind meets the blades at right angle to the rotor shaft. The shaft is typically connected to an electrical generator. The power generated by such types of vertical axis wind turbine at a given wind speed is mainly a function of the rotor diameter, rotor height and the aerodynamics of the blades. A major advantage of the vertical axis wind turbine is that it does not need to be pointed into the wind to operate. Therefore a yaw arrangement is not required.

Initially wind turbines were developed that was taller and/or wider to accommodate a larger rotor to meet the increased power demand, but this approach is limited by the available technologies. Furthermore, in densely populated areas the public opinion is against very large wind turbines. Therefore it is of prime importance now to increase the energy efficiency of the wind turbines to limit their size and/or the number required to provide a given amount of energy, such that environmental impacts are less severe.

WO 2010/098656 describes a wind harvester. The wind harvester is provided with means for increasing its efficiency. A wind turbine is located in the centre and radially surrounded by a power-augmentation-vane. The turbine may be a vertical or horizontal axis wind turbine. The power-augmentation-guide-vane consists of an upper wall duct, a lower wall duct and guide vanes. The power-augmentation-guide-vane collects the wind stream radially from a larger area through an intake. As the wind is directed towards the wind turbine in the centre cross sectional area of the intake is decreasing. The area of the outlet behind the turbine has a gradually increasing cross sectional area. A venturi effect is achieved. According to Bernoulli's principle the wind speed is therefore increased as the wind meets the turbine. Due to the shape of the outlet the pressure behind the turbine decreases, thus more air is induced through the turbine. Therefore the turbine is more effective when located in the centre of the power-augmentation-guide-vane.

Although the above wind harvester may successfully improve the efficiency of a wind turbine the present invention seeks to improve the efficiency in an alternative manner.

### OBJECT OF THE INVENTION

The object of the present invention is to increase the efficiency of a device for harvesting the energy of a fluid stream.

### DESCRIPTION OF THE INVENTION

According to the present invention, this is achieved by device for harvesting the energy of a fluid stream comprising;
a turbine with a rotation axis at right-angle to the fluid stream, said turbine comprising a plurality of blades having a blade foil section, said plurality of blades during its rotation sweeps an annular area around the rotation axis which has an inner and outer perimeter with a first and second radial distance to the rotation axis, and
first and second fluid guide means located opposite each other, with the plurality of blades arranged for rotation there between and arranged for guiding the fluid stream towards said at least one blade, wherein the first and second fluid guide means are formed each with a guide foil section having a suction side, a pressure side and a guide foil incidence angle, wherein each fluid guide means is arranged such that the suction sides of the guide foil sections are facing each other, and wherein an open central area around the rotation axis is provided.

Said plurality of blades is having a blade foil section similar to that of an aircraft wing or a hydrofoil. The foil section may be cambered or without camber, and have a thickness from just above 0% of the chord. The blade foil section is shaped such that it provides a lift and drag component when placed with an incidence angle in a fluid stream. Thus the foil section may have a suction side and a pressure side.

Each blade is configured in the turbine with its leading edge pointed in the direction of rotation and trailing edge opposite the leading edge. The blade has ends separated by an axial distance along the rotation axis.

The turbine has a rotation axis at right-angle to the fluid stream, such that the fluid stream meets the turbine from a radial direction. Said plurality of blades passes through an upstream area in front of the rotation axis during one half turn and through a downstream area behind the rotation axis during the other half turn.

The lift and drag produced by said plurality of blades varies as the blade rotates about the rotation axis. Therefore said plurality of blades may pass non-productive areas during a turn where it provides no torque or negative torque. However the resulting force applied to the turbine by said at least on blade has a torque component that will cause the turbine to rotate.

The first and second fluid guide means are located opposite each other, with the suction side of the guide foil sections facing each other. The first and second fluid guide means are distanced apart with a distance parallel with the rotation axis. As the fluid stream enters between the first and second fluid guide means it is accelerated, such the speed of the fluid stream is increased. This has two main causes. First and foremost the guide foil sections of the first and second fluid guide means begin to generate lift. This generates a suction zone above each guide foil section and between the fluid guide means. Secondly the area between the fluid guide means is first decreasing and thereafter increasing and thereby creating a venturi.

Analysis have shown that the combined effect of the suction zone caused by the lift of the guide foil section and the venturi effect may increase the speed of the fluid stream by as much as a factor of 4 as it passes the first and second fluid guide means compared the free fluid stream speed.

This is known as the velocity ratio which is defined by the speed of the fluid stream through the fluid guide means divided by the speed of the free fluid stream. The velocity ratio would be 1 with a guide foil section formed as a flat plate with zero angle of attack. The velocity ratio exceeds 1 when the guide foil section is configured to generate lift.

The velocity ratio is mainly influenced by the lift and drag characteristics of the guide foil section and the distance between the first and second fluid guide means. In simple terms the magnitude of the pressure in the suction zone is decreasing as the distance from the boundary layer of the guide foil section is increasing.

As the distance between the first and second fluid guide means is increased the velocity effect will decrease until the fluid stream speed increase between the first and second guide means is negligible and the velocity ratio becomes very close to 1.

Therefore it is important to have as small a distance as possible between the first and second guide means. However, in reality the chord wise lift distribution may not be uniform. Therefore by applying detailed flow analysis it is possible to establish the optimum distance for a given configuration of the device. There is, however a trade-off between the distance between the first and second fluid guide means and the required length of said plurality of blades to be able to provide the necessary torque.

Detailed analysis have shown that a satisfactory velocity ratio is achieved when the distance between the first and second fluid guide means is between 0.3 to 0.7, preferably between 0.4 to 0.6, most preferably 0.5 times the chord of the fluid guide means, wherein the chord is defined as the distance between the outer perimeter and the inner parameter of the fluid guide means.

The lift and drag characteristics of the guide foil section are mainly influenced by the shape of the guide foil section and the guide foil incidence angle. The incidence angle determines the angle of attack of the fluid stream on the guide foil section.

The first and second fluid guide means are arranged such that said plurality of blades rotates between them, either during one entire turn or only during part of a turn. Preferably the ends of said plurality of blades are located close to the first and second fluid guide means respectively to maximise the benefit from the velocity ratio.

The guide foil section is arranged such that the radial distance from the rotation axis to the leading edge of the guide foil is equal to or exceeds the first radial distance of the blade foil section and such that the radial distance from the rotation axis to the trailing edge of the guide foil section is equal to or less than the second radial distance.

As explained previously the speed of the fluid stream will increase as it passes between the first and second fluid guide means. The increased speed will increase the forces applied to said plurality of blades compared to a free stream blade. Therefore the magnitude of the torque of said plurality of blades is increased.

The device is connected to a power converter that in turn is connected to a power consumer. For example the power converter may be an electrical generator and the power consumer a battery or a power grid, a shaft and a water pump or a shaft and a grain mill.

The fluid stream may be air for example the wind. The fluid stream may be water for example a river or tide.

The co-axially with the rotation axis the device may have a shaft from which said plurality of blades is suspended. Although the area of the shaft will deduct from the open central area around the rotation axis, this is not considered a factor influencing the technical effect achieved by the invention.

The power output, P, from a wind turbine is given by the well-known expression:

P=½CₚrAV³,

where Cₚ is the power coefficient, r is the density of the fluid, A is the rotor swept area and V is the fluid speed.

From this it is obvious that the increase in speed caused by the introduction of the fluid guide means will increase the power output by the power of 3. For example a device having a turbine and first and second fluid guide means according to the invention and having a velocity ratio of 4 will increase the power output of the device by 4×4×4=64 compared to the same turbine without having the first and second fluid guide means. Therefore it is possible to achieve a much higher power output from a comparably smaller turbine.

The power rating of the device may simply be increased by increasing the diameter of the device but keeping the size and shape of the first and second fluid guide means and the distance between the fluid guide means. The velocity ratio will remain unchanged when increasing the size of the device as described above.

Alternatively the power rating of the device may simply be increased by scaling the components of the device including, but not limited to the turbine and the first and second fluid guide means and keeping the relative distance between the fluid guide means in the axial direction of the axis of rotation. The velocity ratio will remain unchanged when scaling up the device as described above.

According to a further embodiment, the device according to the invention is peculiar in that, said first and second fluid guide means are arranged to partly or fully cover said annular area around the rotation axis.

When the fluid guide means partly cover the annular area around the rotation axis they are orientated upstream in relation to the fluid stream. A velocity ratio in excess of 1 will be applied to the blades in the area where the blades are most efficient.

In locations where the direction of the fluid stream varies the fluid guide means would need to be pivotable about the rotation axis of the turbine, such that the fluid guide means are located upstream. This may be achieved by a yaw mechanism.

When the fluid guide means fully cover the annular area around the rotation axis the device may not need to be pivotable about the rotation axis of the turbine if the device is configured such that it will operate independently of the direction of the fluid stream. This disposes the requirement of a yaw mechanism.

According to a further embodiment, the device according to the invention is peculiar in that the device comprises guide control means configured for varying the position of the first and second fluid guide means, the incidence angle of the foil section and/or the shape of the foil section.

It is herewith achieved that the velocity ratio may be controlled.

The position of the first and second fluid guide means may be adjusted in a radial direction, an axial direction in relation to the rotation axis or a combination thereof.

By adjusting the radial position the annular area through which the plurality of blades passes during rotation may be located at a desired point within the chord-wise lift distribution of the first and second fluid guide means and thereby adjusting the velocity ratio.

By adjusting the position in the axial direction in relation to the rotation axis the distance between the first and second fluid guide means may be varied. As the distance between the first and second fluid guide means is increased the velocity ratio will decrease, thus reducing the force acting on the blade and caused by the fluid guide means.

As the distance between the first and second fluid guide means is increased further the turbine will at some point effectively act, as if it was subject to a free fluid stream and the velocity ratio will become equal to 1.

As the distance between the first and second fluid guide means is decreased the velocity ratio will increase to a maximum value inherent to the design of the device.

The incidence angle of the guide foil section affects the lift and thereby also the velocity ratio. A high incidence angle will increase the lift and a low or even negative incidence angle will decrease the lift.

The shape of the first foil section also affects the lift and thereby the velocity ratio. The shape may be changed by varying the camber.

By varying the parameters above either in isolation or combination the guide control means are able to control the speed and thereby the power production of the device. Furthermore it is possible to limit the speed or even break and stop the turbine to avoid exceeding the limit speed of the turbine.

In one embodiment the control means comprise a guideway for the first and/or second fluid guide.

In another embodiment the control means comprise a mechanism of linkages.

In both embodiments the control means may be driven by a linear actuator, a rotary actuator, an electrical motor and/or a spring mechanism biased for example as a function of the rotational speed of the rotor.

Alternatively the distance may be set manually.

According to an alternative embodiment the guide control means configured for varying the distance between the first and second fluid guide means in a direction parallel with the rotation axis.

It is herewith achieved that the velocity ratio may be controlled.

As the distance between the first and second fluid guide means is increased the velocity ratio will decrease, thus reducing the force acting on the blade and caused by the fluid guide means.

As the distance between the first and second fluid guide means is increased further the turbine will at some point effectively act, as if it was subject to a free fluid stream and the velocity ratio will become equal to 1.

As the distance between the first and second fluid guide means is decreased the velocity ratio will increase to a maximum value inherent to the design of the device.

It is thereby possible to control the speed and thereby the power production of the device. Furthermore it is possible to limit the speed to avoid over speeding the turbine.

The term flap is known from the field of aerodynamics as a mechanical device to temporarily alter the geometry of an airfoil for example during landing and take-off The purpose of the flap is to increase the lift of the airfoil. In this application the term flap is used for a mechanical device that alters the geometry of the foil in order to increase the lift of the foil.

According to a further embodiment, the device according to the invention is peculiar in that, the first fluid guide means comprises a first flap arrangement.

It is herewith achieved that the velocity ratio may be further increased as the first flap arrangement increases the lift of the first fluid guide means.

The first flap arrangement is part of the first fluid guide means. In the upstream area in front of the rotation axis the first flap arrangement is located at the downstream end of the first fluid guide means. In the downstream area behind the rotation axis the first flap arrangement is located at the upstream end of the first fluid guide means.

The first flap arrangement may be selected among commonly known high lift devices. The skilled person may for example select among those described in the publication “Theory of Wing Sections” by Ira H. Abbott and Albert E. von Doenhoff, such as a plain flap, split flap, external airfoil flap, slotted flap, douple-slotted flap. Alternatively as a leading edge slat.

The skilled person may establish the configuration of the first flap arrangement by analysis or experimentation. The configuration is dependent on the overall design of the device and the nominal fluid stream speed that the device is designed for.

According to a further embodiment, the device according to the invention is peculiar in that, wherein the first fluid guide means comprise first flap control means configured for varying the position, deflection and/or shape of the first flap arrangement.

The term deflection relates to the incidence angle of the first flap arrangement in relation to the incidence angle of the first guide foil section.

It is herewith achieved that the velocity ratio increase caused by the introduction of the first flap arrangement may be controlled. It is possible to control the influence from the first flap arrangement by varying the position, the deflection and/or the shape of the first flap arrangement in relation to the guide foil section.

Generally the influence of the first flap arrangement decreases as it is moved further away from the fluid guide foil section. However, this is dependent on the configuration of the first flap arrangement and the fluid guide foil section.

Generally an increase in the deflection of the first flap arrangement will cause the first guide means to provide more lift and thereby increase the velocity ratio until a certain point where further deflection does not cause a further increase in lift. A decrease in the deflection of the first flap arrangement will cause the first flap arrangement to provide less lift and thereby decrease the velocity ratio until a certain point where further deflection does not cause a further decrease in lift. Hence, the same affect as varying the distance between the first and second guide means, may be achieved by the first flap arrangement, namely to control the rotational speed of the turbine.

In relation to shape changes of the first flap arrangement this may for example be achieved by changing the camber of the first flap arrangement. In general an increased camber of the first flap arrangement will increase the lift of the first fluid guide means.

The first flap control means may comprise a guideway and/or a linkage mechanism. The first flap position and the first flap deflection may be individually controlled or move in concert.

The first flap control means may be driven by a linear actuator, a rotary actuator, an electrical motor and/or a spring mechanism biased for example as a function of the rotational speed of the rotor.

According to a further embodiment, the device according to the invention is peculiar in that, the second fluid guide means comprises a second flap arrangement.

It is herewith achieved that the velocity ratio may be further increased as the second flap arrangement increases the lift of the second fluid guide means.

The second flap arrangement is part of the second fluid guide means. In the upstream area in front of the rotation axis the second flap arrangement is located at the downstream end of the first fluid guide means. In the downstream area behind the rotation axis the second flap arrangement is located at the upstream end of the first fluid guide means.

The second flap arrangement may be selected among commonly known high lift devices. The skilled person may for example select among those described in the publication “Theory of Wing Sections” by Ira H. Abbott and Albert E. von Doenhoff, such as a plain flap, split flap, external airfoil flap, slotted flap, douple-slotted flap. Alternatively as a leading edge slat.

The skilled person may establish the configuration of the second flap arrangement by analysis or experimentation. The configuration is dependent on the overall design of the device and the nominal fluid stream speed that the device is designed for.

According to a further embodiment, the device according to the invention is peculiar in that, the second fluid guide means comprise second flap control means configured for varying the position, deflection and/or shape of the second flap arrangement.

The term deflection relates to the incidence angle of the second flap arrangement in relation to the incidence angle of the second guide foil section.

It is herewith achieved that the velocity ratio increase caused by the introduction of the second flap arrangement may be controlled. It is possible to control the influence from the second flap arrangement by varying the position, the deflection and/or the shape of the second flap arrangement in relation to the guide foil section or the second flap deflection.

Generally the influence of the second flap arrangement decreases as it is moved further away from the fluid guide foil section. However, this is dependent on the configuration of the second flap arrangement and the fluid guide foil section.

Generally an increase in the deflection of the second flap arrangement will cause the second guide means to provide more lift and thereby increase the velocity ratio until a certain point where further deflection does not cause a further increase in lift. A decrease in the deflection of the second flap arrangement will cause the second flap arrangement to provide less lift and thereby decrease the velocity ratio until a certain point where further deflection does not cause a further decrease in lift. Hence, the same affect as varying the distance between the second and second guide means, may be achieved by the second flap arrangement, namely to control the rotational speed of the turbine.

In relation to shape changes of the second flap arrangement this may for example be achieved by changing the camber of the second flap arrangement. In general an increased camber of the second flap arrangement will increase the lift of the second fluid guide means.

The second flap control means may comprise a guideway and/or a linkage mechanism. The second flap position and the second flap deflection may be individually controlled or move in concert.

The second flap control means may be driven by a linear actuator, a rotary actuator, an electrical motor and/or a spring mechanism biased for example as a function of the rotational speed of the rotor.

According to a further embodiment, the device according to the invention is peculiar in that, the blade foil section comprises a plurality of blade sub-foil sections.

It is herewith achieved that lift produced by the blade may be increased considerably.

Furthermore the stall characteristics of such a blade foil section having a plurality of blade sub-foil sections is advantageous as the blade foil section will be able to work at a high fluid stream speed without stalling.

The blade sub-foil sections may be configured in a hybrid tandem/biplane configuration, where the blade sub-foil sections are placed in tandem, but partly overlapping and having individual incidence angles.

The each blade sub-foil section may have an identical shape to decrease manufacturing cost.

The effect achieved is similar to a wing having multiple fixed slots as described in the publication “Theory of Wing Sections” by Ira H. Abbott and Albert E. von Doenhoff.

The blade foil section may comprise two, three, four, five or more blade sub-foil sections.

According to a further embodiment, the device according to the invention is peculiar in that, the guide foil section comprises a plurality of guide sub-foil sections.

It is herewith achieved that an even higher velocity ratio may be achieved because the lift of the guide foil section is increased.

Furthermore the stall characteristics of such a guide foil section having a plurality of guide sub-foil sections is advantageous as the guide foil section will be able to work at a high fluid stream speed without stalling.

The guide sub-foil sections may be configured in a hybrid tandem/biplane configuration, where the guide sub-foil sections are placed in tandem, but partly overlapping and having individual incidence angles.

The effect achieved is similar to a wing having multiple fixed slots as described in the publication “Theory of Wing Sections” by Ira H. Abbott and Albert E. von Doenhoff.

The guide foil section may comprise two, three, four, five or more guide sub-foil sections.

According to a further embodiment, the device according to the invention is peculiar in that, the shape of the first and/or second guide means as projected on a plane normal to the axis of rotation is selected among circular, triangular, rectangular, polygonal shapes or a combination thereof.

Embodiments having a circular shape with an open central area will provide a uniform increase in the velocity ratio independent of the direction of the fluid stream in relation to the first and/or second guide means.

Embodiment having triangular, rectangular, rectangular or polygonal shapes with an open central area may provide a non-uniform increase in the velocity ratio dependent of the direction of the fluid stream in relation to the first and/or second guide means.

The first embodiment may be complex to manufacture, but more efficient than the latter. The second embodiment may be less complex to manufacture, but less efficient compared to the first mentioned embodiment.

The first and/or second guide means may be open or closed. A closed guide means will extend less than 360° about the axis of rotation and a closed guide means will extend exactly 360° about the axis of rotation.

According to a further embodiment, the device according to the invention is peculiar in that, the device comprises an axle co-axial with the rotation axis and a rim which is suspended from the axle by a plurality of spokes, wherein said plurality of blades is attached to the rim.

It is herewith achieved that the turbine may be provided in a manner of little complexity. The spokes will minimise the drag in a tangential direction as well as in the axial direction, while at the same time suspending the blades. Therefore the part of the fluid stream that passes through the open central area around the rotation axis may be maximised due to the minimised resistance in the axial direction.

Furthermore the spokes will make the balancing and alignment of the turbine flexible and quick.

This will increase the overall efficiency of the device.

All previously described embodiments may comprise blade control means for adjusting the incidence of the blade foil section.

The incidence of the blades may be adjusted during a rotation to optimise the variations in lift and drag that the blade experience during a rotation.

Furthermore the object of the invention is achieved by a system for harvesting the energy of a fluid stream comprising a plurality of devices according to any of the previously described embodiments and combinations thereof, wherein the devices are arranged co-axially in a stack.

It is herewith achieved that the production may be increased without increasing the ground area occupied by the system.

The turbines of the stack may share a common axle and power consumer, for example an electrical generator. In this case the torque of the system is increased.

### DESCRIPTION OF THE DRAWING

The invention will be explained in more detail below with reference to the accompanying drawing, where:

FIG. 1a shows a plan view of a first embodiment of the device according to the invention,

FIG. 1b shows a section view through A-A on FIG. 1a,

FIG. 2a shows a plan view of a second embodiment of the device according to the invention,

FIG. 2b shows a section view through B-B on FIG. 2a,

FIG. 3 shows a plan view of a third embodiment of the device according to the invention,

FIG. 4a shows a plan view of a turbine of a fourth embodiment of the device according to the invention,

FIG. 4b shows a section view through the fourth embodiment of the invention,

FIG. 4c shows a plan view of a fifth embodiment of the invention,

FIG. 5 shows a computational fluid dynamics analysis result illustrating the flow in the area of the fluid guide means, and

FIG. 6 shows a section view of an embodiment of the system according to the invention.

### DETAILED DESCRIPTION OF THE INVENTION

In the explanation of the figures, identical or corresponding elements will be provided with the same designations in different figures. Therefore, no explanation of all details will be given in connection with each single figure/embodiment.

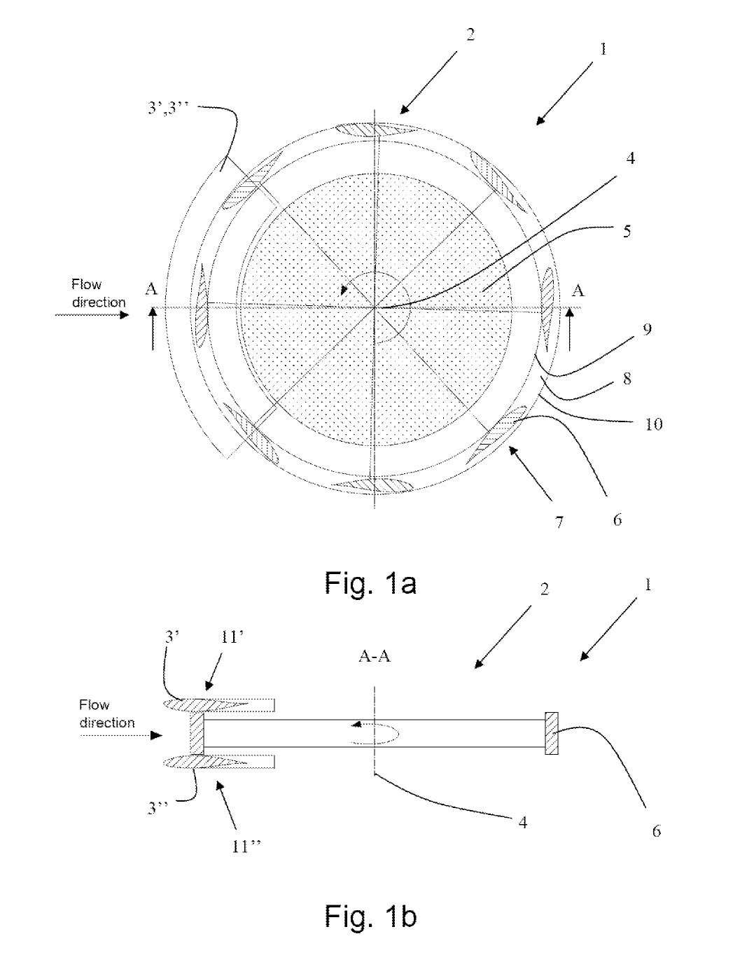

FIG. 1a and 1b shows a first embodiment of the device 1 for harvesting the energy of a fluid stream.

The device 1 comprises a turbine 2 and a first and second fluid guide means 3′,3″ located opposite each other.

The turbine 2 is of a type with a rotation axis 4 at right-angle to the fluid stream. In the first embodiment the turbine 2 comprises eight blades 6 having a blade foil section 7. In alternative embodiments the turbine 2 may have two, three, four, five, six, seven, nine, ten, eleven, twelve, thirteen or more blades 6.

Each blade 6 during its rotation sweeps an annular area 8 around the rotation axis 4 which has an inner and outer perimeter 9, 10 with a first and second radial distance to the rotation axis. An open central area 5 around the rotation axis is provided.

The direction of rotation of the turbine 2 is counter-clockwise. Alternatively the turbine 2 may have a clockwise direction of rotation. This influences the orientation of the blade foil section 7.

The blades 6 are arranged for rotation between the first and second fluid guide means 3′,3″.

The first and second fluid guide means 3′,3″ are each formed with a guide foil section 11′, 11″ a having a suction side, a pressure side and a guide foil incidence angle. The suction sides of the guide foil sections 11′, 11″ are facing each other. The fluid stream is guided towards the blade 6 and accelerated as it passes the first and second fluid guide means 3′,3″.

In the first embodiment the first and second fluid guide means 3′,3″ are arranged to partly cover the annular area 8 around the rotation axis 4. The first and second fluid guide means 3′,3″ is shaped as a sector of an annulus in a plane normal to the rotation axis 4.

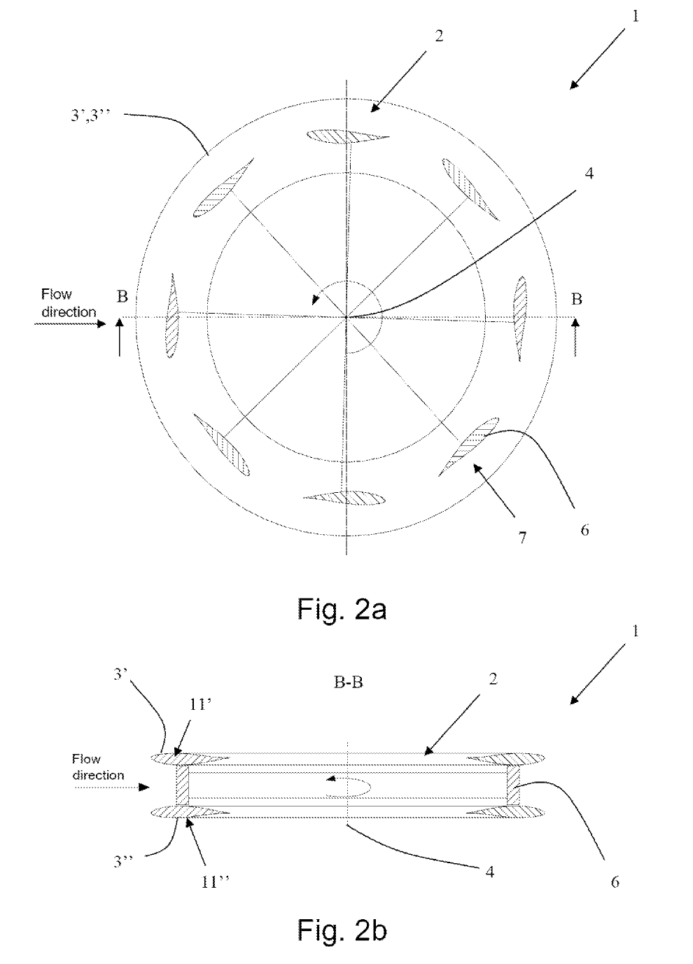

FIGS. 2a and 2b shows a second embodiment of the device 1 for harvesting the energy of a fluid stream.

The second embodiment differ from the first embodiment in that the first and second fluid guide means 3′,3″ are arranged to fully cover the annular area 8 (see FIG. 1a) around the rotation axis 4. The first and second fluid guide means 3′,3″ is shaped as an annulus in a plane normal to the rotation axis 4.

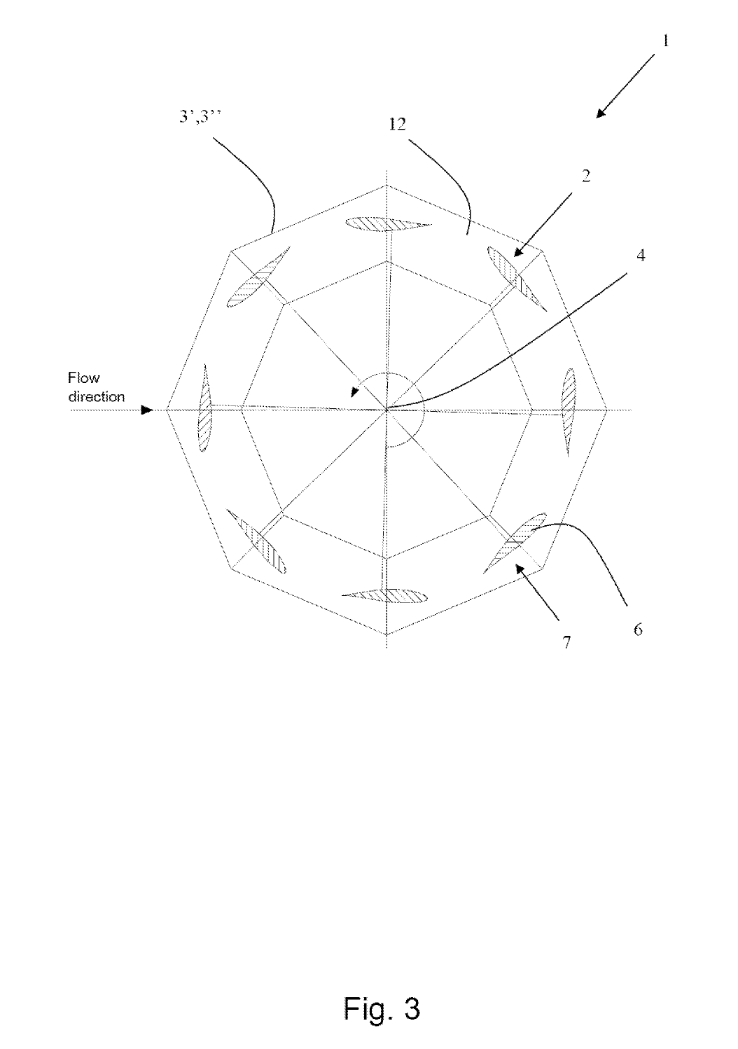

FIG. 3 shows a third embodiment of the device 1 for harvesting the energy of a fluid stream.

The third embodiment differ from the first embodiment in that the first and second fluid guide means 3′,3″ are arranged to fully cover the annular area 8 (see FIG. 1a) around the rotation axis 4.

Furthermore the third embodiment differ from the second embodiment in that the first and second fluid guide means 3′,3″ has a polygonal ring shape.

The first and second fluid guide means 3′,3″ are composed of sections 12 of an elongate profile having a uniform cross-section along its length for example an extruded profile.

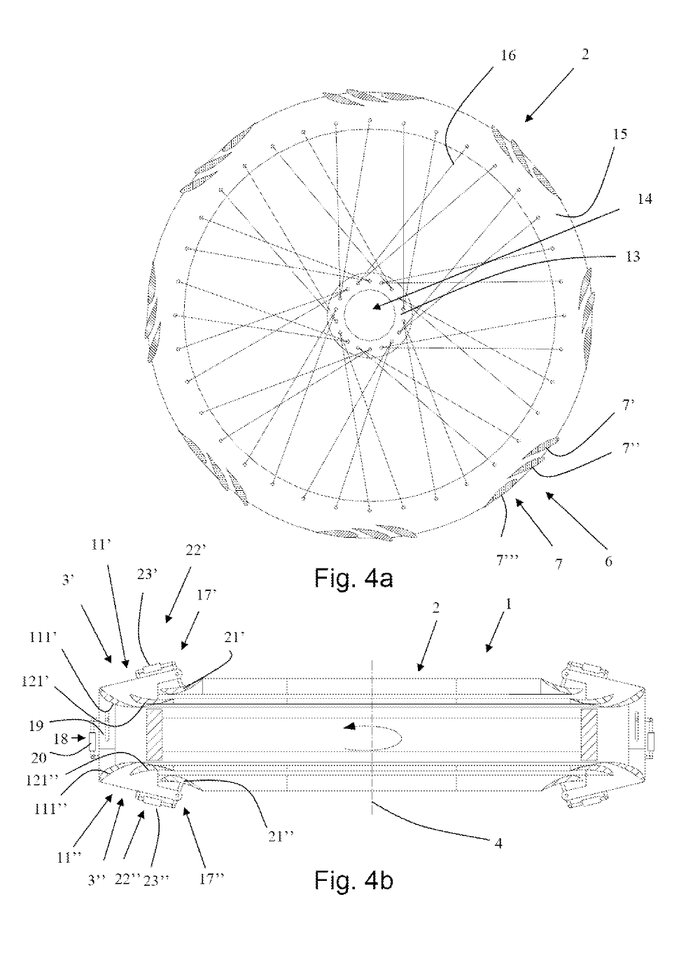

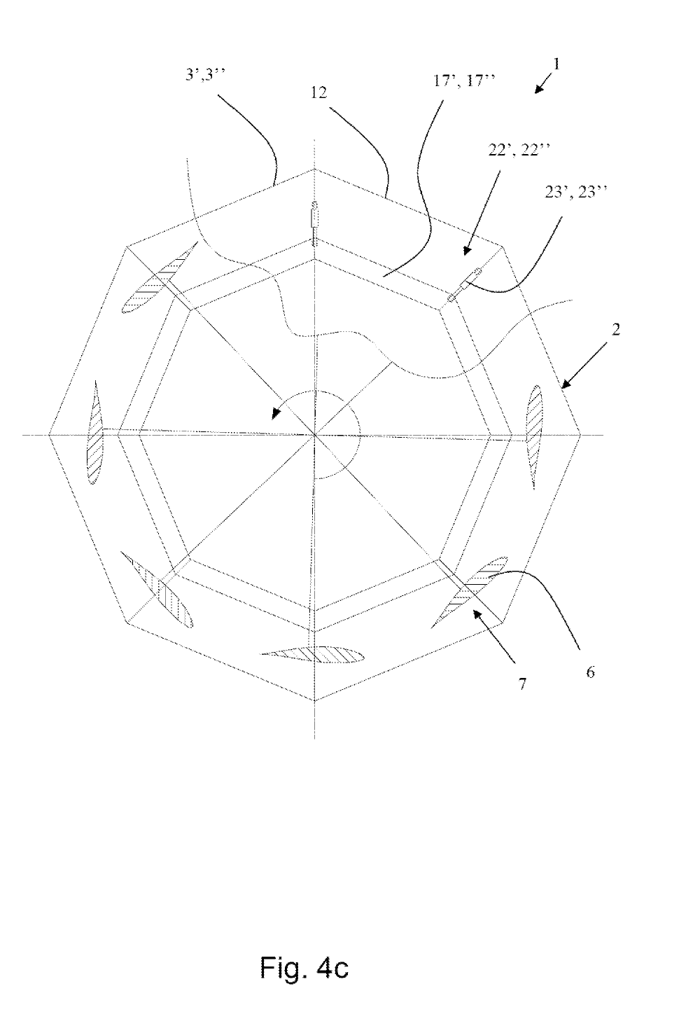

FIGS. 4a to 4c shows a fourth embodiment of the device 1 for harvesting the energy of a fluid stream.

FIG. 4a shows a plan view of the turbine 2 of the fourth embodiment. The turbine 2 is of a type with a rotation axis 4 (see FIG. 4b) at right-angle to the fluid stream. Turbine 2 comprises eight blades 6 having a blade foil section 7. In alternative embodiments the turbine 2 may have two, three, four, five, six, seven or more blades 6.

Each blade foil section 7 comprises a plurality of blade sub-foil sections 7′, 7″, 7′″. In the fourth embodiment the blade sub-foil sections 7′, 7″, 7′″ are identical. In alternative embodiments they may be dissimilar.

This configuration of the blade foil section 7 has advantageous stall characteristics.

The turbine 2 comprise central flange 13 with a central aperture 14 that is configured for receiving an axle (not shown) and mounting the turbine to the axle (not shown) and a rim 15 to which the blades 6 are attached and a plurality of spokes 16 mounted between the central flange 13 and the rim 15 for suspending the rim 15 from the axle.

FIG. 4b shows a section view of the fourth embodiment. The first and second fluid guide means 3′,3″ located opposite each other.

The first and second fluid guide means 3′,3″ are each formed with a guide foil section 11′, 11″ having a having a suction side, a pressure side and a guide foil incidence angle. The suction sides of the guide foil sections 11′, 11″ are facing each other. The fluid stream is guided towards the blade 6 and accelerated as it passes the first and second fluid guide means 3′,3″.

In the fourth embodiment each guide foil section 11′, 11″ comprises a plurality of guide sub-foil sections 111′, 121′, 111″, 121″. In the fourth embodiment the guide sub-foil sections 111′, 121′, 111″, 121″ are identical. In alternative embodiments they may be dissimilar.

This configuration of the guide foil section 11′, 11″ has advantageous stall characteristics.

A guide control means 18 are arranged to vary the position of the first and second fluid guide means 3′, 3″. In the embodiment shown the position variation is constrained in the axial direction in relation to the rotation axis 4. In other embodiment guide control means may be configured to vary the radial position of the first and second fluid guide means 3′, 3″, incidence angle of the guide foil section 11′, 11″ and/or the shape of the guide foil section 11′, 11″. The guide control means comprise a guideway 19 and an actuator 20 to vary the position.

The first fluid guide means 3′ comprise a first flap arrangement 17′ and the second fluid guide means 3″ comprise a second flap arrangement 17″.

Each flap arrangement 17′, 17″ comprise a flap foil section 21′, 21″.

The first fluid guide means 3′ comprise a first flap control means 22′ for varying the the position and deflection of the first flap arrangement 17′. In other embodiments the first flap control means 22′ may be configured for also varying the shape of the flap foil section 21′.

The first flap control means 22′ comprise an actuator 23′ for varying the position and deflection of the first flap arrangement 17′.

The second fluid guide means 3″ comprise a second flap control means 22″ for varying the position and deflection of the second flap arrangement 17″. In other embodiments the second flap control means 22″ may be configured for also varying the shape of the flap foil section 21″.

The second flap control means 22″ comprise an actuator 23″ for varying the position and deflection of the second flap arrangement 17″.

FIG. 4c shows a plan view of a fifth embodiment of the invention.

The fifth embodiment differ from the third embodiment in that the first fluid guide means 3′ comprise a first flap arrangement 17′ and the second fluid guide means 3″ comprise a second flap arrangement 17″.

Each flap arrangement 17′, 17″ comprise a flap foil section 21′, 21″ (see FIG. 4b).

The first fluid guide means 3′ comprise a first flap control means 22′ for varying the position and deflection of the first flap arrangement 17′. In other embodiments the first flap control means 22′ may be configured for also varying the shape of the flap foil section 21′.

The first flap control means 22′ comprise an actuator 23′ for varying the position and deflection of the first flap arrangement 17′.

The second fluid guide means 3″ comprise a second flap control means 22″ for varying the position and deflection of the second flap arrangement 17″. In other embodiments the second flap control means 22″ may be configured for also varying the shape of the flap foil section 21″.

The second flap control means 22″ comprise an actuator 23″ for varying the position and deflection of the second flap arrangement 17″.

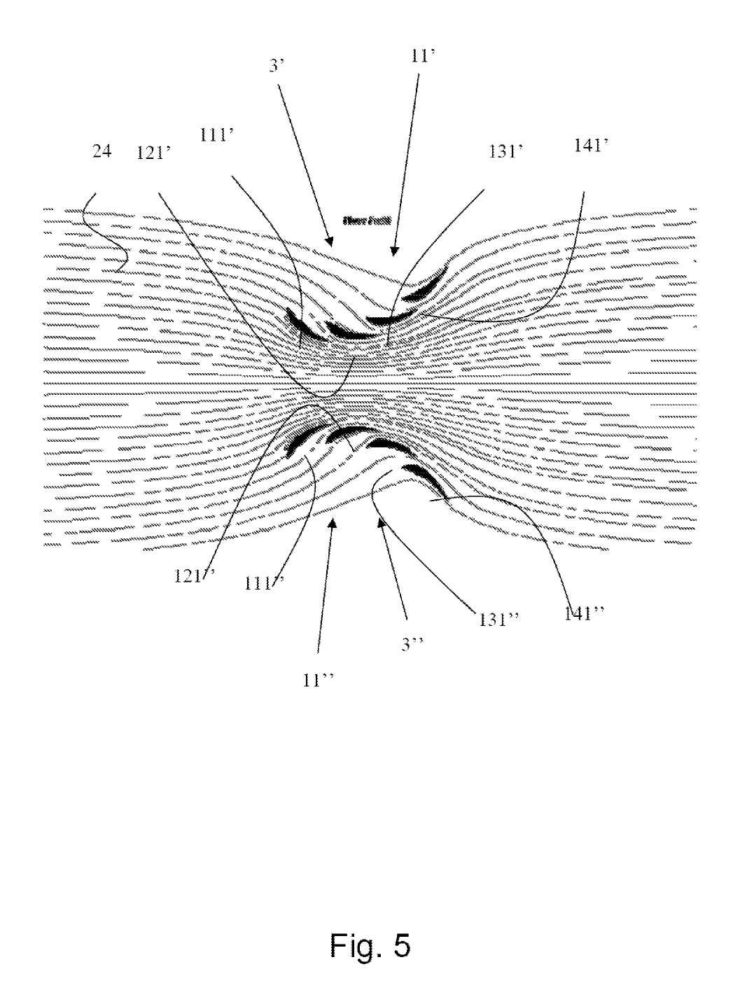

FIG. 5 shows a computational fluid dynamics analysis result illustrating the flow in the area of the fluid guide means 3′, 3″.

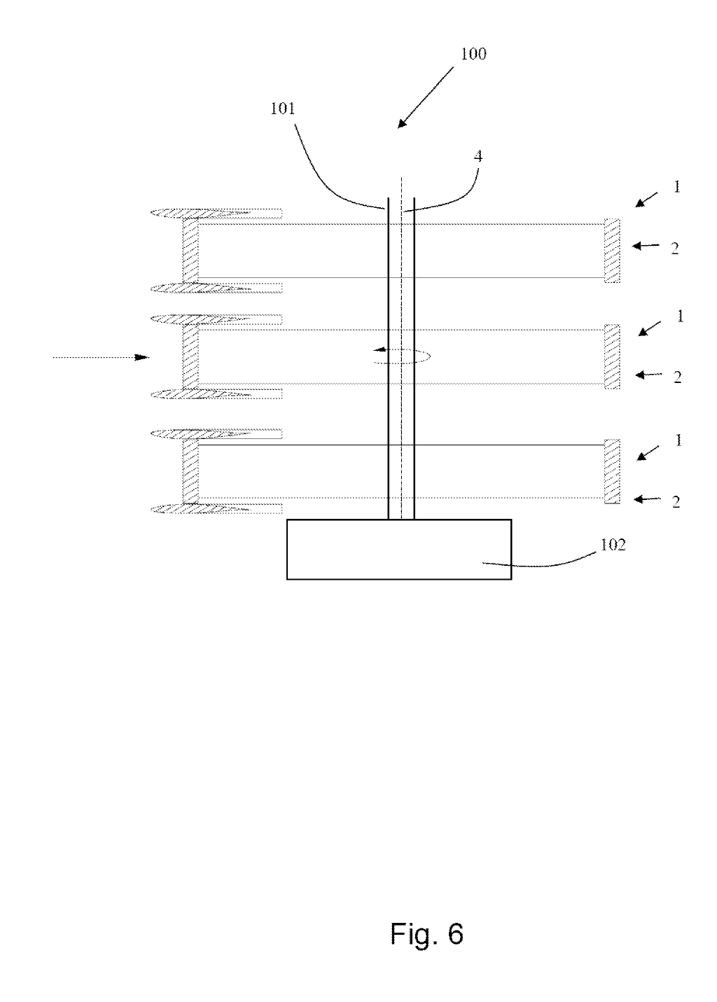

En the embodiment shown in FIG. 6 the guide foil section 11′, 11″ each comprise four guide sub-foil sections 111′, 121′, 131′, 141′, 111″, 121″, 131″, 141″.

The flow lines 24 indicate the pressure field. A small distance between individual flow lines 24 indicates low pressure and a large distance indicates high pressure. The distance between the flow lines 24 between the fluid guide means 3′, 3″ correspond to a velocity ratio of approximately 4.

FIG. 6 shows an embodiment of the system 100 according to the invention for harvesting the energy of a fluid stream.

In the embodiment shown the system 100 comprise three devices 1 arranged co-axially in a stack. The turbines 2 are connected to the same axle 101 that is co-axial with the rotation axis 4 of the devices 1.

The system 100 further comprises a power converter 102. The power converter 102 may for example be an electrical generator, a water pump, an air pump or a grain mill.

1. A device for harvesting the energy of a fluid stream comprising:
a turbine with a rotation axis at a right-angle to the fluid stream, said turbine comprising a plurality of blades having a blade foil section, said plurality of blades during its rotation sweeps an annular area around the rotation axis which has an inner and an outer perimeter with a first and a second radial distance to the rotation axis, and
a first and second fluid guide means located opposite each other, with the plurality of blades arranged for rotation therebetween and arranged for guiding the fluid stream towards at least one blade, wherein the first and second fluid guide means are formed each with a guide foil section having a suction side, a pressure side and a guide foil incidence angle, wherein each fluid guide means is arranged such that the suction sides of the guide foil sections are facing each other, and wherein an open central area around the rotation axis is provided.

2. The device according to claim 1, wherein said first and second fluid guide means are arranged to partly or fully cover said annular area around the rotation axis.

3. The device according to claim 1, wherein the device comprises a guide control means configured for varying a position of at least one of the first and second fluid guide means, the incidence angle of the foil section and the shape of the foil section.

4. The device according to claim 1, wherein the first fluid guide means comprises a first flap arrangement.

5. The device according to claim 4, wherein the first fluid guide means comprise a first flap control means configured for varying at least one of the position, deflection and shape of the first flap arrangement.

6. The device according to claim 1, wherein the second fluid guide means comprises a second flap arrangement.

7. The device according to claim 6, wherein the second fluid guide means comprise a second flap control means configured for varying at least one of the position, deflection and shape of the second flap arrangement.

8. The device according to claim 1, wherein the blade foil section comprises a plurality of blade sub-foil sections.

9. The device according to claim 1, wherein the guide foil section comprises a plurality of guide sub-foil sections.

10. The device according to claim 1, wherein the shape of the first and second fluid guide means as projected on a plane normal to the axis of rotation is selected among circular, triangular, rectangular, polygonal shapes or a combination thereof.

11. The device according to claim 1, wherein the device comprises an axle co-axial with the rotation axis and a rim which is suspended from the axle by a plurality of spokes, wherein said plurality of blades is attached to the rim.

12. A system for harvesting the energy of a fluid stream comprising a plurality of devices according to claim 1, wherein the plurality of devices are arranged co-axially in a stack.
